(19) United States
(12) Patent Application Publication
(10) Pub. No.: US 2016/0279462 A1
(43) Pub. Date: Sep. 29, 2016

(54) Exercise mat with integral visual and audio instruction aid

(71) Applicant: Patricia Schott Sutherland, Fremont, CA (US)

(72) Inventor: Patricia Schott Sutherland, Fremont, CA (US)

(21) Appl. No.: 14/545,072

(22) Filed: Mar. 24, 2015

(51) Int. Cl. A63B 21/00; G09B 5/02; G09B 5/04

(52) U.S. Cl. CPC A63B 21/4037; G09B 5/04; G09B 5/02

(57) ABSTRACT

An exercise mat with integral visual and audio instruction aid. The mat is made of flexible and portable material suitable for use during physical exercise. A removable visual instruction panel is attached to sheet depicting a set of physical exercises. Graphic images of feet, hands or other images are depicted and printed on main portion of the mat, for proper form. An audio device attached to the mat is capable of providing verbal instruction for a specific exercise routine. A plurality of LED lights may be attached to said sheet that illuminate sequentially to aid user in performing exercises. Because of the numeric order, this allows user a more fluid sense exercise. This systematic arrangement establishes a learned, directional routine, that allows the user to adjust exercises however, the order, because of numbers. A preferred embodiment includes and allows placement of alternate exercise routines.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of exercise accessories and more specifically to an exercise mat with an integral visual and audio instruction aid.

The instruction of physical exercise is very helpful to people who want to exercise but are not sure of the correct physical positions or sequence of an exercise routine. Various methods of instruction are currently available for this purpose. These include instructional videos that can be played through TV's or other video devices and instructional audio programs that can be played through conventional audio devices such as digital audio players.

Some people use resilient exercise mats to help act as a cushion between themselves and the floor or ground while exercising. Although exercise mats help provide a suitable resilient surface for exercising activity, and current instructional videos or audio programs help guide a person in the proper position and sequence of exercise movements, there are deficiencies in the prior technology.

First, the current exercise mats do not have printed graphic images on them to help a person know where to put his or her hands, feet or other anatomical body parts. Proper form is imperative for a safe and effective exercise routine , for results to be obtained through an intelligently orchestrated workout provided by this Mat. Second, if a person is watching a video of an exercise routine, they need to use the appropriate electronic equipment such as a TV set or other digital video device and they need to constantly look over to that device while at the same time attempting to do the exercise described in the program. The viewing equipment is relatively expensive and the act of viewing is distracting to the process of exercising. If a person is simply listening to an audio version of an exercise program, they may have trouble visualizing exactly how to do the exercise and where to put their hands or feet while doing the exercise. Even if the user has a visual aid for helping to see how to perform the exercise, they often have difficulty in translating what they see into the proper positioning of their own body while performing on an exercise mat.

### BRIEF SUMMARY OF THE INVENTION

The primary object of the invention is to provide a flexible and portable exercise mat that includes an instructional system of graphics printed on, or otherwise attached to, the mat to show placement of hands and feet. A second object includes an affixed audio device that verbally leads the user through an exercise routine.

Another object of the invention is to provide an exercise mat that incorporates LED lights to help direct the user during the process of the exercise routine.

Yet another object of the invention is to provide an exercise mat that lets the user perform an exercise without having to look away at an external TV or other graphic image thereby allowing the user to focus on the exercise being performed.

Another object of the invention is to provide an exercise mat that allows the user to remove the audio description of an exercise routine and replace it with another audio description of a different exercise routine.

Another object of the invention is to provide an exercise mat and instructional system that is relatively inexpensive to manufacture and purchase.

A further object of the invention is to provide an exercise mat that allows the user to remove the graphic portions of the mat and replace them with alternate graphic panels.

Another object of the invention is to provide a well, constructed routine so the user does not need to plan a workout. It has been done for them.

In addition to these, another object of the invention is the exercise template allows for more than 225 exercises.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an exercise mat with integral visual and audio instruction means comprising: a flexible and portable sheet of thin resilient material suitable for use during physical exercise, visual pictorial instruction graphics attached to said sheet depicting a set of physical exercises, an audio device attached to said sheet capable of providing verbal instructions for a specific exercise routine, and a plurality of LED lights attached to said sheet that illuminate sequentially aid the user in performing a set of exercises.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 1A is a perspective view of the invention with details.

FIG. 2 is an exploded perspective view of the invention.

FIG. 2A is an exploded perspective view of the invention with details

FIG. 3 is a perspective view of the electronic portion of the invention.

FIG. 3A is a perspective view of the electronic portion of the invention with details.

FIG. 4 is a perspective view of the invention

FIG. 4A is a perspective view of the invention with details

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

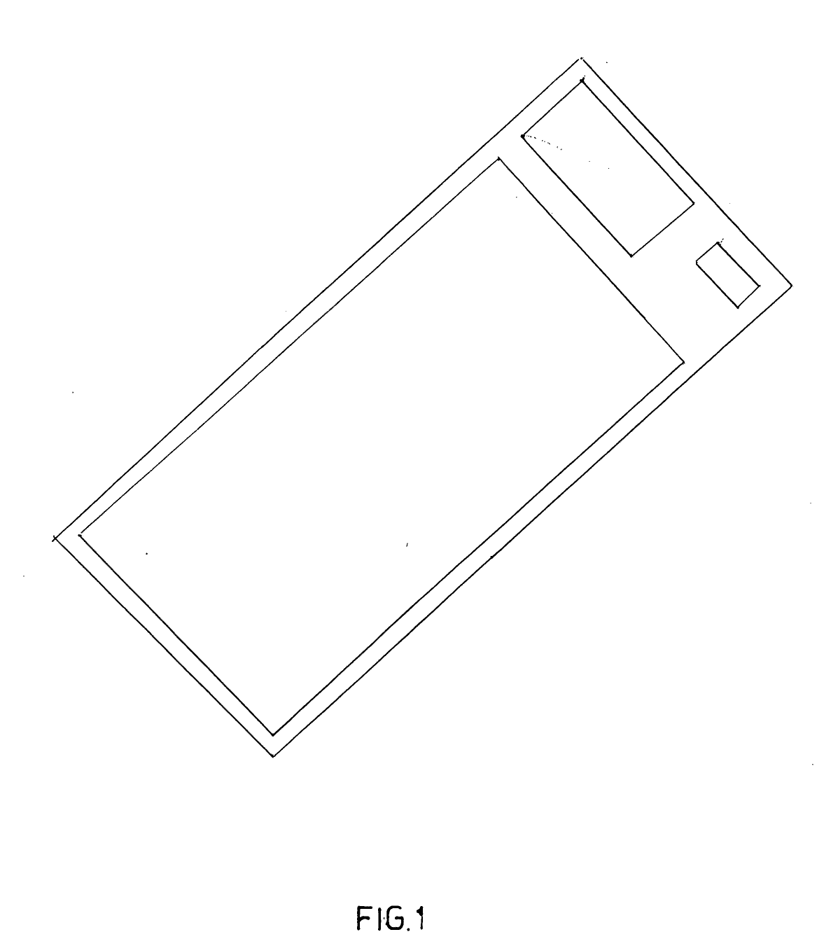

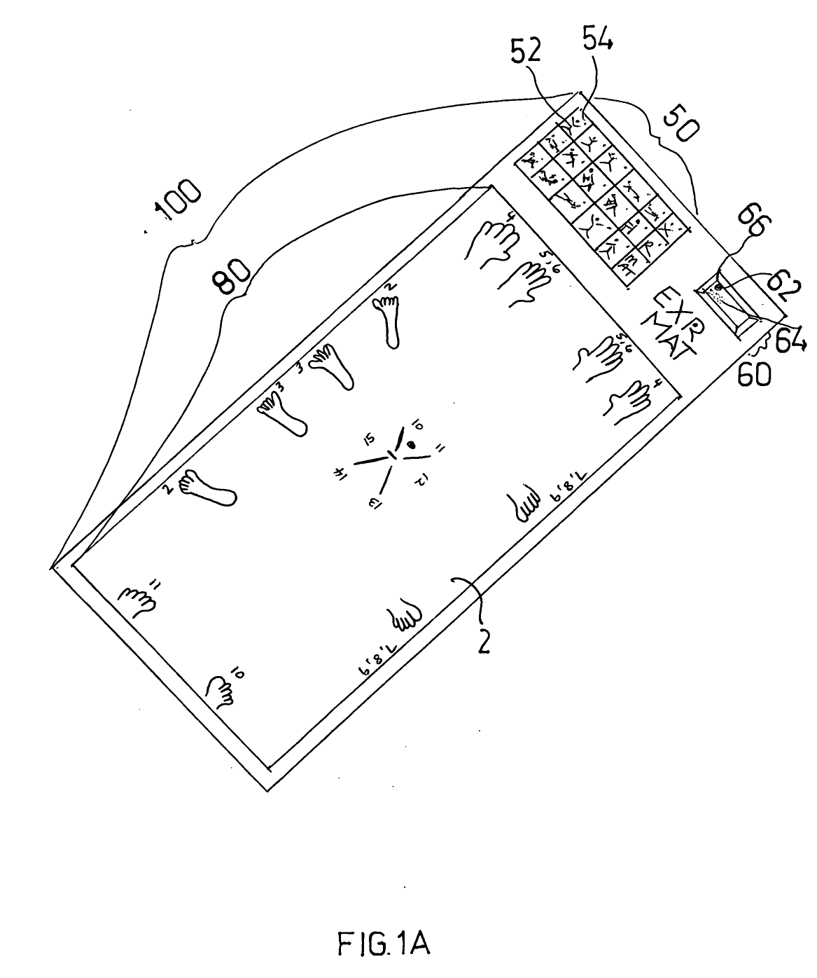

Referring to FIG. 1 we see a perspective view of Mat depicting the shape, electronic portion, audio portion and surrounding periphery. This perspective provides a basic premise of construct for the exercise mat.

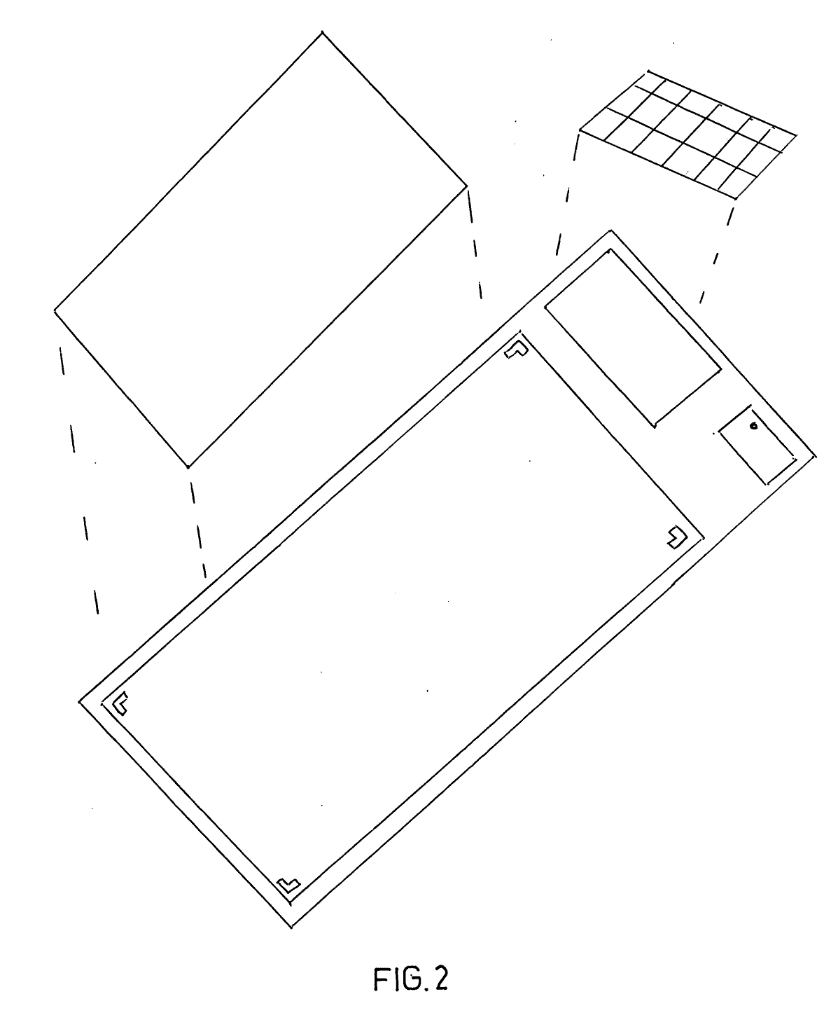

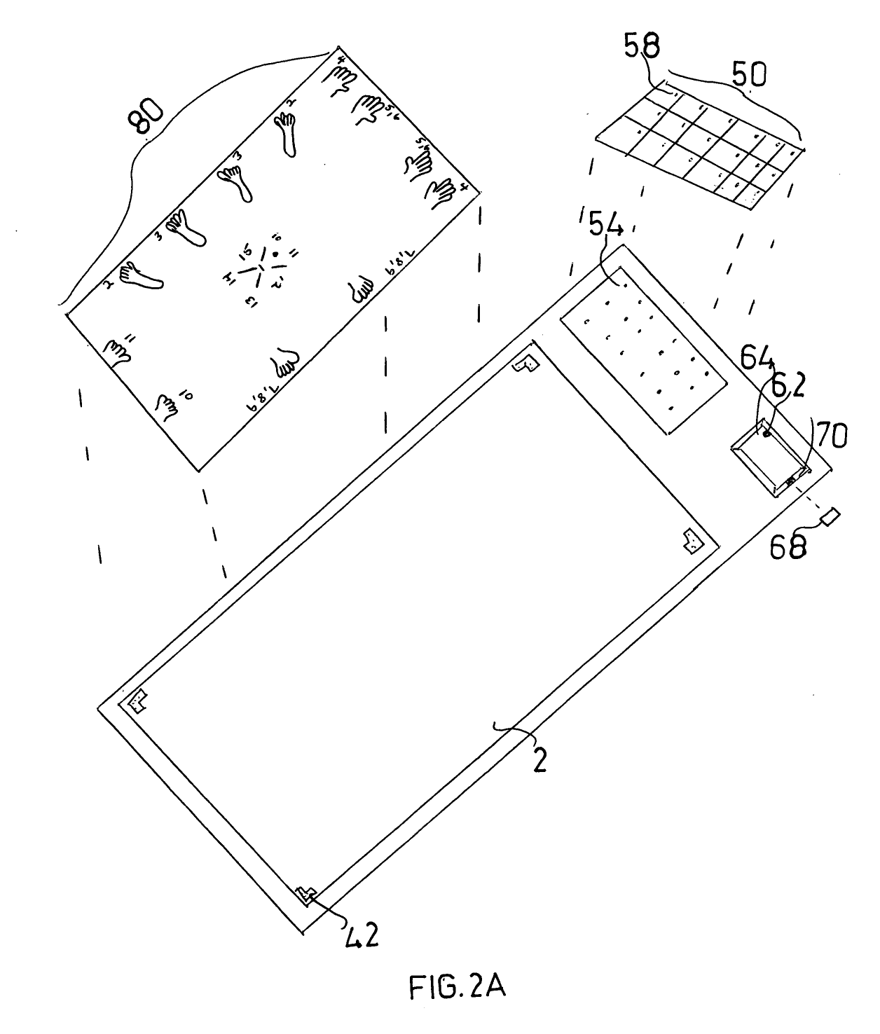

Referring now to FIG. 1A we see a perspective view of the present invention 100. The entire rectangular sheet of the present invention is made of flexible and resilient material suitable for performing physical exercise on. Preferably, the mat is rubber-like and has a cushioning effect between the user and a hard floor or ground surface. On one end of the mat there are a series of graphic images 50 depicting a person doing a set of exercises. Each graphic box 52 contains a specific graphic representation on a person performing a specific physical movement. This format of showing graphic images of specific exercise poses and additional graphics to show the user where to place his or her hands is the primary embodiment of the present invention. An additional embodiment includes each box 52 having an LED 54 that illuminates as that particular exercise is being explained via an audio output device 60, which is also mounted to mat 2. The audio device can be a standard digital audio player such as an MP3 player, or other standard audio playback device. The sound is amplified by a standard amplification circuit 86 and played through a low profile speaker 90. The entire audio circuit is housed in a low profile housing 66. A microprocessor 74 located within the housing 66 provides a timing circuit for the LED's so that when the user presses the “Start” button 62, the illumination of each LED in each graphic block is in sync with the verbal instructions coming from the digital audio player. The timing instructions for the sequencing of the LED's are encoded into the audio memory chip 68 shown in FIG. 2. Of course an alternate embodiment can include the use of LED lights without the presence of an audio component, or the presence of an audio component without the use of LED lights.

The removable memory chip feature allows for the possibility of removing and replacing the graphic panel 50 and memory chip 68 with a different set of exercises, and having the LED's properly timed for the new exercise routine. The main portion of the mat 80 includes printed graphic images 3, 4, 8,and 10, for example, showing the user where to place his or her feet or hands or other anatomical parts during a specific exercise. These placements are crucial for getting maximum value from the exercise, and is one of the reasons why other traditional exercise programs are less effective than the one being described and illustrated here. Additionally, the user of the present invention does not have to turn his or her head at a possibly awkward position to view a TV or other graphic image that would normally be some distance from the user.

FIG. 2 shows an exploded view of the invention and shows how the graphic panel 50 and main exercise graphic panel 80 can be removed and replaced by other panels. the panels 50, 80 are held to the main substrate 2 by standard means such as Velcro 42, 44 or snaps. Of course, the invention 100 may also be made without the ability to remove and replace graphic panels 50, 80 thereby providing only one exercise routine per mat. However, provided current technology, user may be able to receive updated exercise routines via social media that will directly apply to design of graphics. LED's 74 are embedded into the substrate mat 2 and line up with apertures 58 in the graphic panel 50.

FIG. 2A is an exploded view of Mat depicting electronic portion, graphic portion and audio portion. This perspective illustrates how resilient material 100 may attach to bottom aspect of Mat, via snaps or Velcro. Also depicted in upper left hand corner is the LED aspect and how it may fit within the construct of Mat. The potential audio portion is explained visually in upper right hand aspect of Mat. The view depicted illustrates the Mat's versatility and potential for change in routine.

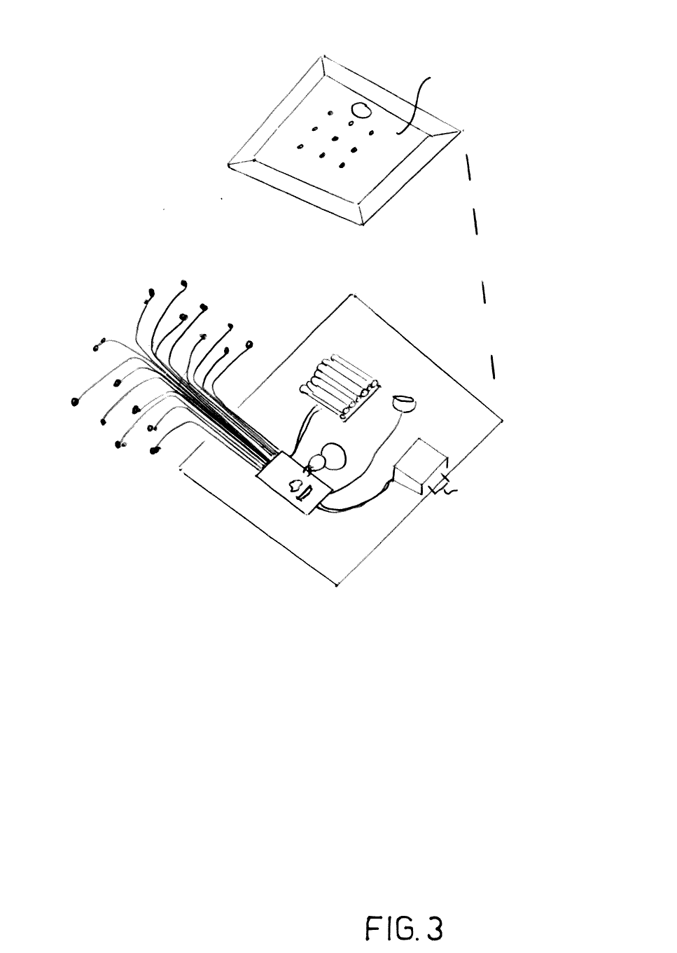

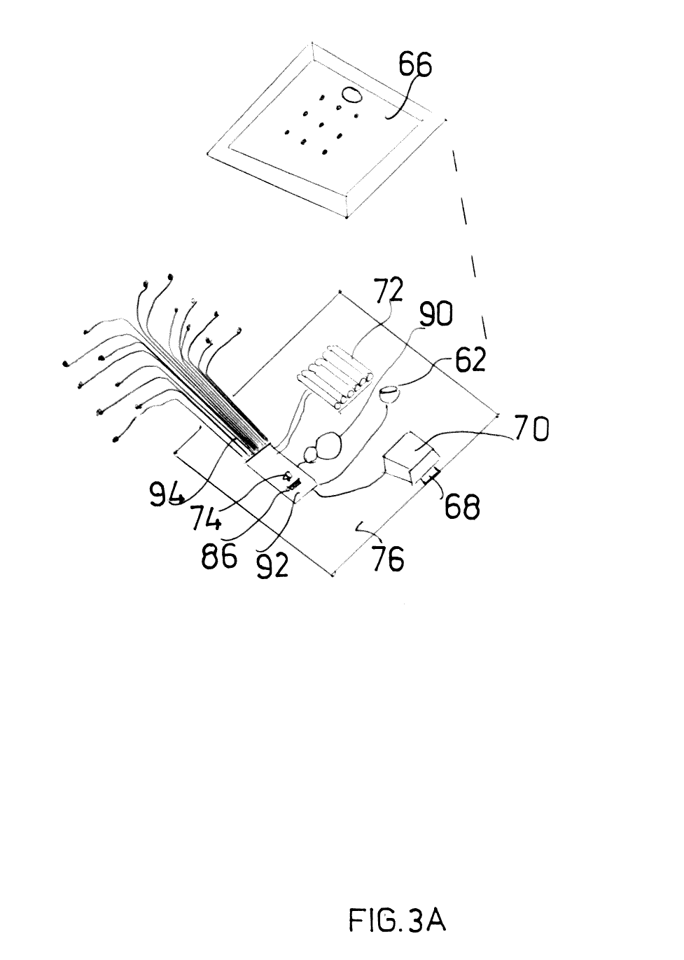

FIG. 3 is a perspective view of the electronic portion of the invention. Housing portion, a battery supply, a digital audio player, speaker ,as well as PCB. A microprocessor, amplifier, and wire are depicted in this illustration.

FIG. 3A is the perspective view of the electronic portion of the invention in detail. The housing portion 66 has been removed to reveal a base plate that supports a battery supply 72. The exploded view illustrates a digital audio player 70, a low profile speaker 90 as well as PCB 92 which holds a microprocessor 74 and audio amplifier 86. Wires 94 attach LED's 54 to the microprocessor 74.

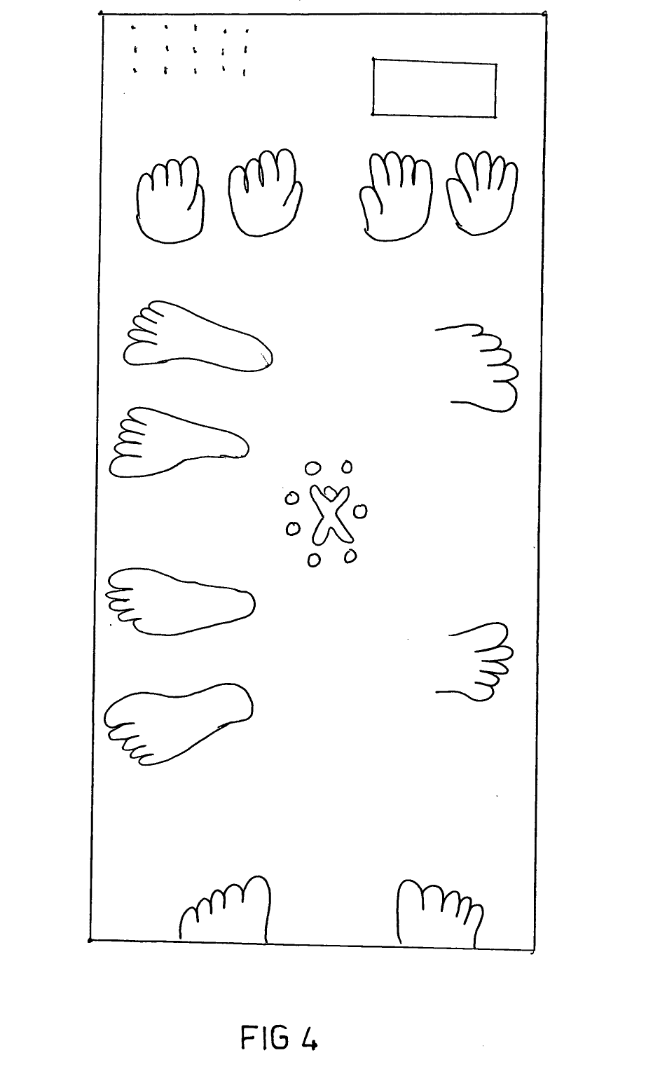

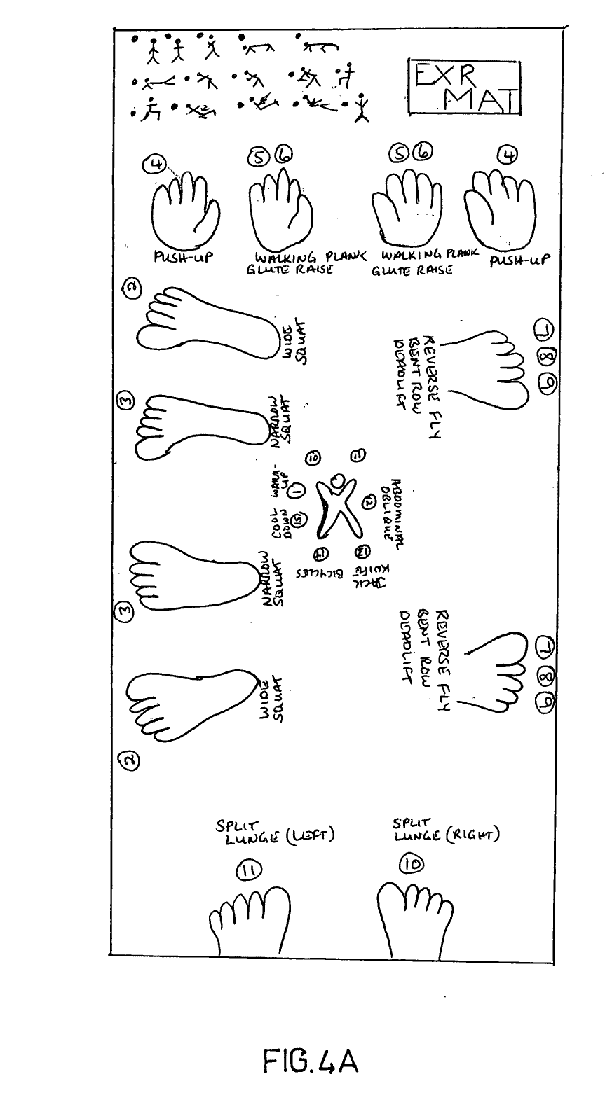

FIG. 4 is a perspective view of the invention with suggested graphics , and logo without said electronics. It is made of resilient material suitable for a well rounded, fitness routine, designed with knowledge of anatomy and physiology. Said placement of graphics ensure correct, biomechanical form when applied as designed.

FIG. 4A is a perspective view of the invention with suggested graphics and logo, with detailed direction for user to achieve workout. These details contain written exercises which correspond to said graphic. The numeric order, thus corresponds to graphic for an easy to follow, directional routine, because of design. A lighted depiction,placed in left hand corner of figure, may correspond with exercise. Said body graphics, guide user through 15 suggested exercises. The Mat is made of resilient material suitable for a well rounded, fitness routine designed with knowledge of anatomy, physiology, biomechanics, and sensory motor skill. FIG. 4A and it's perspective view shall not be limited to said material.

The entire exercise mat of the present invention 100 is lightweight and portable so that the user can perform his or her exercises anywhere including outdoor locations that have no access to electricity or wireless Internet access. Additionally, the components of the invention 100 are relatively inexpensive, so the final retail price of the invention 100 is well within the means of ordinary individuals interested in obtaining an ideal physical workout.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An exercise mat with integral instruction by means comprising:
a flexible and portable sheet of thin, resilient material suitable for use during exercise.
a visual graphic instruction panel attached to said sheet depicting a plurality of physical exercises.
said graphic instruction panel also including graphic representations to show the user where to place his/her feet, hands, and/or other body parts on said exercise surface.

2. An exercise mat with integral instruction by means as claimed in claim 1 further comprising:
a digital audio device and associated power supply integrally embedded or attached to said sheet capable of providing verbal instructions for a specific exercise routine;

3. An exercise mat with integral instruction by means as claimed in claim 1 further comprising:
a plurality of LED lights and associated power supply attached or embedded into said sheet that illuminate sequentially to aid the user in performing a set of exercises. wherein, said LED lights are timed via a microprocessor, to coincide with the said audio instructions allowing said user to match audio instructions with the corresponding said pictoral exercise graphic.

4. An exercise mat with integral with visual and audio instruction by means as claimed in claim 1 wherein said visual instruction panel is removable and replaceable to allow the placement of alternate exercise routines.

5. An exercise mat with integral visual and audio instruction by means as claimed in claim 1 wherein the audio information and LED timing information are stored on a standard memory chip that can be inserted or removed from said digital audio device.

6. An exercise mat with integral instruction as claimed in claim 1 wherein exercises are ordered numerically in clockwise fashion.

7. An exercise mat with integral instruction as claimed in claim 1 wherein exercises are not limited to exercise on graphic.

8. An exercise mat with integral instruction as claimed in claim 1 whereas the sequence of 15 exercises, not limited to said exercises, starting with large muscle groups, is especially advantageous for a healthy exercise regimen and routine, whereas, the large muscle groups prepare the joints, muscles, and connective tissue. whereas, the more finite muscle groups exercises to follow, later in the routine, as it is imperative that the body be well prepared for such movements. Said routine, is designed to prepare the user for said exercises.

9. An exercise mat with integral instruction as claimed in claim 1, whereas, The sequence of 15 exercises, but not limited to, starting with large muscle groups are especially advantageous for a healthy exercise regimen and routine. The large muscle groups, as it is suggested , warm up the user for said routine.

10. An exercise mat with integral instructions as claimed in claim 1, whereas, having feet placement in the correct position for a proper range of motion and distance between limbs is carefully measured out on a template for the mat. Proper position allows for safety and a results-driven repetition within the program.

11. An exercise mat with integral instructions as claimed in claim 1 whereas, with respect to placement also comes angles. The positioning of the feet aspect of the mat allows for the angles of the joints articulated to be in the correct placement for an accurate and safe exercise. Without the guidance on the mat ,said exercise would be done incorrectly and consequently putting the individual in a vulnerable position.

12. An exercise mat with integral instruction as claimed in claim 1, whereas, having the hand placement in the correct position for a proper range of motion allows the individual to achieve correct angle and range of motion . The mat instructs ,guides and places the user in the correct positioning for a safe and proper bout of said exercises. The hand graphic, may be any suggested graphic.

13. An exercise mat with integral instruction as claimed in claim 1, whereas, exercises are ordered numbers to guide the user in the direction best set out, for a well balanced overall basic workout.

14. An exercise mat with integral instruction as claimed in claim 1, whereas coordinating numbered exercises and pictures of such exercises are another benefit for the mat or other surfaces. By giving the user a visual depiction corresponding with the number on the mat , exercise program is simpler to follow.

15. An exercise mat with integral instruction as claimed in claim 1, whereas the design of mat is a unique design because of the order of exercises.

16. An exercise mat with integral instruction as claimed in claim 1 whereas exercises performed by repetition before workout can be achieved in 4 minutes or less.

17. An exercise mat with integral instruction as claimed in claim 1 whereas exercises may be timed giving the user control over time spent on exercise.

18. An exercise mat with integral instructions as claimed in claim 1, whereas, mat can be considered cardiovascular workout depending on speed of user.

19. An exercise mat with integral instructions as claimed in claim 1, where is mat and exercise can be considered a resistance program.

20. An exercise mat with integral instructions as claimed in claim 1, whereas, the design of said mat is specifically set for a whole body fitness program but not limited to said program.

21. An exercise mat with integral instruction as claimed in claim 1, whereas, said mat or surface has the ability to be a flexibility program.

22. An exercise mat with integral instruction as claimed in claim 1, whereas, the user while using large muscle groups ,can be considered a high calorie utilizer, because of the order of exercises.

23. An exercise mat with integral instruction as claimed in claim 1, whereas mat can be used as a plyometric apparatus by following the guidelines for a high intensity calorie utilizing workout.

24. An exercise mat with integral instruction as claimed in claim 1, whereas exercise regimen when used properly can provide strength for the user.

25. An exercise mat with integral instruction as claimed in claim 1, whereas; exercise regimen when used properly can provide muscle and connective tissue flexibility for the user.

26. An exercise mat with integral instruction has claimed in claim 1, whereas, exercise regimen when used properly can provide muscle endurance for the user.

27. An exercise mat with integral instruction as claimed in claim 1, whereas, exercise regimen when used properly may cause the release of endorphins said to create a feeling of happiness.

28. An exercise mat with integral instruction as claimed in claim 1, whereas, exercise regimen when used properly on said mat, may cause and provide the sense of good health, wellness and fitness.

29. An exercise mat with integral instruction as claimed in claim 1, whereas, the 32″x 80″ design is larger than the average workout mat ,therefore is a more complete and spacious area for exercise.

30. An exercise mat with integral instruction as claimed in claim 1, whereas, The artwork, graphics, and numeric order are critical in that the sequencing of visual depictions on the mat, direct the user in the coming and staying engaged in the exercise routine.

31. An exercise mat with integral instruction as claimed in claim 1, whereas, the importance of staying engaged is critical so the individual will achieve their goals if they remain true to exercises . said design and exercises assist the user to stay engaged.

32. An exercise mat with integral instruction as claimed in claim 1, whereas, said mat or other surface may be used as a resistance program. A weighted Body Bar may be included with exercise mat.

33. An exercise mat with integral instruction as claimed in claim 1 ,whereas, body bars may provide resistance to an already body resistance program ,consequently demanding a higher energy output therefore generating an increase in caloric utilization. Eventually this leads to weight loss ,a more toned body mass and overall better fitness.

34. An exercise mat with integral instruction as claimed in claim 1 whereas, said weighted Body Bar may be specifically designed to fit inside the mat when rolled up and stored.

35. An exercise mat with integral instruction as claimed in claim 1, whereas, weighted dumbbells may also be used to add resistance to an already resistant exercise program. user may use this extra resistance to further develop flexibility ,muscle tone and muscle. endurance.

36. An exercise mat with integral instructions as claimed in claim 1, whereas, 4 mm thickness of mat provides a more comforting routine than when performed used without.

37. An exercise mat with integral instruction as claimed in claim 1 whereas, the thickness is directly considered for ease on the user's joints and body as a whole. This mat provides cushion to encourage completion of routine.

38. An exercise mat with integral instruction as claimed in claim 1, whereas, the workout can be done in 4 minutes or less depending on time chosen for each exercise.

39. An exercise mat with integral instruction as claimed in claim 1, whereas, the workout can be done in 4 minutes or less depending on number of repetitions chosen by the user for each exercise. Exercises followed in numeric fashion can be achieved by allowing the format of the exercise mat to lead the user in a clockwise fashion.

40. An exercise mat with integral instruction as claimed in claim 1, whereas, mat is easily stored.

41. An exercise mat with integral instruction as claimed in claim 1, whereas, hands and feet not limited to any graphic, are placed strategically for proper form have specific exercises.

42. An exercise mat with integral instruction as claimed in claim 1, whereas, position of said graphics aid the user to keep and perform proper biomechanics.

43. An exercise mat with integral instruction as claimed in claim 1, whereas, position of said graphics may be used as a teaching tool to special needs individuals.

44. An exercise mat with integral instruction as claimed in claim 1, whereas, set exercises if followed properly will be executed with proper form and biomechanics required for said exercises because of positioning of graphics.

45. An exercise mat with integral instruction as claimed in claim 1, whereas, design of said exercises may be a replacement of gym membership, because of its totality of optional exercises.

46. An exercise mat with integral instruction as claimed in claim 1, whereas, color schematics , red, with black and white graphics, allow contrast visually, thus making direction of exercises more visible and easy to follow instruction.

47. An exercise design with integral instruction as claimed in claim 1, whereas, it is suggested that continued use would provide a healthier lifestyle through exercise.

48. An exercise mat with integral instruction as claimed in claim 1, whereas, said graphics may aid individuals who struggle to follow directions with such exercise programs.

49. An exercise mat with integral instruction as claimed in claim 1, whereas, mat may aid young individuals by providing an activity other than a sedentary lifestyle. As a result, said exercise design and program may thwart the onset of juvenile diabetes through exercise.

50. An exercise mat with integral instruction as claimed in claim 1, whereas, mat designed around the concept of making fitness as accessible as possible to as many people as possible.
